(19) United States
(12) Patent Application Publication
(10) Pub. No.: US 2023/0305909 A1
(43) Pub. Date: Sep. 28, 2023

(54) SYSTEM FOR INVOKING FOR A PROCESS

(71) Applicants: Mao YU, Redmond, WA (US); Microsoft Technology Licensing, LLC, Redmond, WA (US)

(72) Inventors: Arvind MUTHUKRISHNAN, Woodinville, WA (US); Siddharth UPPAL, Bothell, WA (US); Ojasvi CHOUDHARY, Seattle, WA (US); Mao YU, Bellevue, WA (US); Tatiana CRISTEA, Kirkland, WA (US)

(21) Appl. No.: 18/020,244

(22) PCT Filed: Aug. 18, 2021
(86) PCT No.: PCT/US2021/046567

§ 371 Date: Feb. 7, 2023

(30) Foreign Application Priority Data
Sep. 14, 2020 (LU) LU102060

(51) Int. Cl. G06F 9/54; H04L 12/18

(52) U.S. Cl. CPC G06F 9/546; H04L 12/1813; G06F 9/543

(57) ABSTRACT

A system and method performed by a data processing system for invoking, from a first application, a process of a second application, is described. The system accesses, from the first application, a first message that indicates an operation request from a first member of a message group. The system invokes a process at the second application by submitting the operation request to the second application. The system receives an output of the process from the second application. Based on the output of the process and an identity of a second member of the message group, the system embeds a control element into the second message designated for delivering only to the second member. The embedded control element, upon activation based on a user input from the second member, causes the data processing system to interface with the second application to access a final result of the process.

### CLAIM OF PRIORITY

This application claims the benefit of priority to Luxembourg Patent Application No. LU102060, filed Sep. 14, 2020 which application is incorporated herein by reference in its entirety.

### TECHNICAL FIELD

The subject matter disclosed herein generally relates to a computer-implemented method for invoking a process of an application from another application and for generating adaptive content in group messages based on the workflow. Specifically, the present disclosure addresses systems and methods for requesting an operation of a third-party application based on predefined data mapped to a content of the request.

### BACKGROUND

Computer users heavily rely on communication tools such as email and instant messaging applications. However, users are required to switch activities between different application in order to access different functions from other applications. As such, a user in the midst of composing an email must pause his/her email application activity to launch and operate another application to access an operation from the other application. A computer that operates both the email application and a second application requires separate application input from the user at different instances: for example, the email application may not interface with the second application and as such requires a user input that may depend on an output of the second application. Similarly, the second application may not interface with the email application and thus also requires intervention from the user. As such, the computer does not efficiently operate both the email application and the second application because the computer relies on the user's intervention to relay information between both applications.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure is deployed, in accordance with some example embodiments.

FIG. 2 is a block diagram illustrating an invocation system in accordance with one example embodiment.

FIG. 3 illustrates a block diagram illustrating an attribute module in accordance with one example embodiment.

FIG. 4 illustrates a block diagram illustrating a message generator module in accordance with one example embodiment.

FIG. 5 is a flow diagram illustrating a method for invoking a process in accordance with one example embodiment.

FIG. 6 is a flow diagram illustrating a method for updating a message in accordance with one example embodiment.

FIG. 7 illustrates a routine in accordance with one example embodiment.

FIG. 8 illustrates an interaction diagram illustrating an operation of the invocation system in accordance with one example embodiment.

FIG. 9 illustrates an interaction diagram illustrating an operation of the invocation system in accordance with one example embodiment.

FIG. 10 illustrates a screenshot of a communication application of a first group member in accordance with one example embodiment.

FIG. 11 illustrates a screenshot of a communication application of a first group member in accordance with one example embodiment.

FIG. 12 illustrates a screenshot of a communication application of a first group member in accordance with one example embodiment.

FIG. 13 illustrates a screenshot of a communication application of a second group member in accordance with one example embodiment.

FIG. 14 illustrates a screenshot of a communication application of a first group member in accordance with one example embodiment.

FIG. 15 illustrates a screenshot of a communication application of other group members in accordance with one example embodiment.

FIG. 16 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The term “message application” is used herein to refer to a computer-operated application or platform that enables different computer users to communicate with one another. Non-limiting examples of the message application include: an email application that enables users to read and write emails, a chat/text/message application that enables a user to send and receive short messages to and from other users, and a social media application that enables a user to communicate with other groups of users.

The term “group message” is used herein to refer to a group communication that is accessible by a group of users of the message application. The group communication includes a message or an email that is communicated from one member of the group to other members of the group and viewable by one or more members of the group. Non-limiting examples of a group message include: an email thread between group members, an instant message/chat session between chat group members, and a group posting on a social media platform where the group posting is only accessible by members of a group identified on the social media platform.

The term “process application” is used herein to refer to a computer-implemented application that operates on a computing device. The process application can perform or operate an algorithm corresponding to a process, such as a workflow process. The workflow process identifies a series of sequential tasks that are performed or computed based on user-defined rules or conditions. The process application is distinct and separate from the message application. For example, the message application does not include the process application and operates independently from the process application, and vice-versa. In another example, the message application and the process application can operate on the same computing device or on different devices. Non-limiting examples of the process application include: an application that operates a process workflow based on inputs from users, an application that performs an algorithm based on conditions and inputs provided by users, an application that displays a graphical user interface based on data, user inputs, and results of an algorithm operation based on the data and user inputs. For example, the process application receives data (e.g., token, hash) from the message application, identifies the workflow process corresponding to the token or hash, and performs the workflow process. Examples of workflow process include performing an operation that requires initial input, provides an intermediary output to a user, receives additional input from the user, and continues processing the workflow process based on the additional input to generate a final result of the workflow process.

The present application describes a system and method for triggering a workflow process of an application from a message application. The system monitors group messages between members of a group of users operating the message application. The system detects that a first group message from a first group member. The first group message indicates an operation request of a process application. Upon detection of the operation request, the system provides content from the first group message along with the operation request to the process application. The process application receives the operation request and generates an output based on a process algorithm associated with the operation request. The system retrieves the output from the process application and generates a second group message for members of the group. The system identifies a second group member based on the output of the process application or an identity of the first group member. The system embeds a control element in the second group message designated for the second group member. The system sends the second group message to the members of the group via the message application. The system detects a user input from the second group member. The user input indicates of a selection from the control element. For example, the user input indicates a selection of an input among a choice of several inputs presented in the control element. The system routes the user input to the process application to move the process forward or finalize a result of the process based on the user input. The system receives the final result from the process and modifies the second group message to indicate the final result.

In one example embodiment, a system and method performed by a data processing system for invoking, from a first application, a process of a second application, is described. The system accesses, from the first application, a first message that indicates an operation request from a first member of a message group. The system invokes a process at the second application by submitting the operation request to the second application. The system receives an output of the process from the second application. Based on the output of the process and an identity of a second member of the message group, the system embeds a control element into the second message designated for delivering to the second member, and excludes the control element from the second message designated for delivering to the other members of the message group. The embedded control element, upon activation based on a user input from the second member, causes the data processing system to interface with the second application to access a final result of the process.

As a result, one or more of the methodologies described herein facilitate solving the technical problem of accessing a process of a process application from a group communication application. Traditionally, the group communication application is isolated from the process application and requires the user to intervene and interface between both applications. For example, a first member of a group of users of the communication application seeking to perform a process external to the communication application would manually identify the process application and call the process application. The process application will also request the first member to manually identify a second member pertinent to the operation request of the process application. The communication application requires further input from the first member to generate a group message communicated to all members of the group. The group message may include information that is only pertinent to the second member. As such, the traditional communication application would require a separate communication channel with the second member. Thus, the traditional paradigm would require multiple operations and interventions from the first member to generate and send multiple messages among different members of the group to operate the process of the process application.

As such, one or more of the methodologies described herein may obviate a need for certain efforts or computing resources. Examples of such computing resources include processor cycles, network traffic, memory usage, data storage capacity, power consumption, network bandwidth, and cooling capacity. In one example, the present application describes a technical solution of interfacing two distinct applications via an API for communication of data between both applications while filtering processing result data and recipients of the data and processing result data.

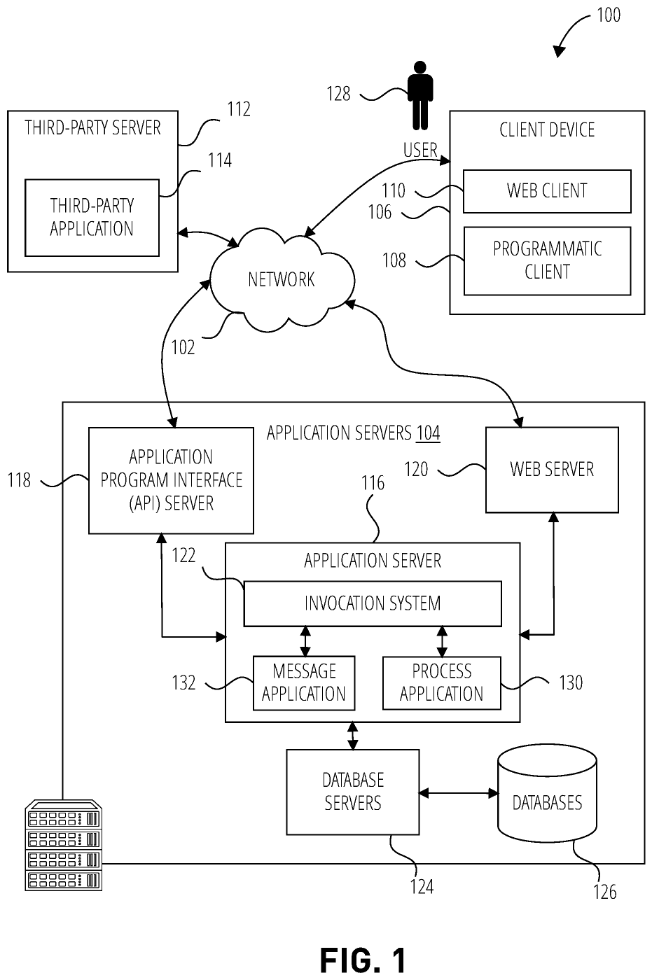

FIG. 1 is a diagrammatic representation of a network environment 100 in which some example embodiments of the present disclosure may be implemented or deployed. One or more application servers 104 provide server-side functionality via a network 102 to a networked user device, in the form of a client device 106. A user 128 operates the client device 106. FIG. 1 illustrates one client device 106. However, the application servers 104 may communicate with more than one client device. The client device 106 includes a web client 110 (e.g., a browser operating a web version of an application), a programmatic client 108 (e.g., a client-side enterprise communication application such as Microsoft Teams™ or Microsoft SharePoint™) that is hosted and executed on the client device 106. The web client 110 communicates with a message application 132 via the programmatic interface provided by the Application Program Interface (API) server 118.

An Application Program Interface (API) server 118 and a web server 120 provide respective programmatic and web interfaces to application servers 104. A specific application server 116 hosts the message application 132, a process application 130, and an invocation system 122. Each message application 132, process application 130, and invocation system 122 include components, modules and/or applications.

The message application 132 includes a server-side communication application (e.g., a server-side enterprise communication application such as Microsoft Teams™ or Microsoft SharePoint™) that is hosted and executed on the application server 116. The message application 132 communicates with the client-side communication application (e.g., programmatic client 108) of each client device (e.g., client device 106) to receive messages from and provide messages to client devices.

In one example embodiment, the message application 132 enables the exchange of messages between members of a group of users. For example, the message application 132 receives a group message from the client device 106 and provides the group message to other client devices associated with the group members. In one example embodiment, the message application 132 includes a group messaging application that enables instant chat/messages between members of a group. For example, the group message application enables the client device 106 to send and receive messages to and from the group. In another example embodiment, the message application 132 includes an email application that enables members of a group to communicate amongst themselves. For example, the email application enables the client device 106 to send and receive an email thread among members of an email group. In other words, the same email is distributed among all members of the email group. In another example embodiment, the message application 132 includes a social network platform application that enables the client device 106 to post and read messages from members of a group. For example, the social network platform application enables the client device 106 to post and read a message on a channel or a page associated with the group. The members of the group can also post additional messages or read the message from the client device 106 on the channel or page of the social network platform. Those of ordinary skill in the art will recognize that other forms of communication platforms may be used to enable communication among a group of users.

The process application 130 includes an algorithm for operating a process and computing a result or an output of the process. For example, the algorithm includes a workflow process algorithm for processing an operation request based on workflow input. In another example, the algorithm includes a computation algorithm that performs a function or operation based on a sequence of user inputs.

The invocation system 122 includes an application that interfaces with both the message application 132 and the process application 130. In one example, the invocation system 122 monitors group messages from the message application 132 and detects an operation request in a first group message from a first group member (e.g., a group message from user 128). The invocation system 122 identifies the process application 130 associated with the operation request and invokes a process by requesting the process application 130 to operate the process based on with the operation request and an identity of the user 128. The invocation system 122 receives an output of the process from the process application 130, identifies a second group member of the message group, and generates a second group message that indicates the output of the process.

In one example embodiment, the invocation system 122 embeds a control element in the second group message designed for delivery to the second member. The invocation system 122 provides the second group message to the group members via the message application 132. Every group member can view and access the content of the second group message except for the embedded control element. Only the second member can view and access the embedded control element. In another example embodiment, the invocation system 122 generates a first version of the second group message designated for all group members, and a second version of the second group message designated for the second group member. The second version of the second group message includes the embedded control element. In yet another example embodiment, the invocation system 122 generates a first version of the second group message designated for the first group member, a second version of the second group message designated for the all group member, and a third version of the second group message designated for the second group member. The first version of the second group message includes content (e.g., response) provided by the second group member. The third version of the second group message includes the embedded control element.

The invocation system 122 detects a selection of a user input from the second group member via the embedded control element and communicates the user input to the process application 130 for further processing and finalizing the process (that is dependent on the additional user input from the second member). The invocation system 122 retrieves a final result of the process from the process application 130 and modifies the second group message to indicate the final result of the process. In one example embodiment, the invocation system 122 generates a third group message that indicates the final result of the process. The third group message is accessible by all group members.

The application server 116 is shown to be communicatively coupled to database servers 124 that facilitates access to an information storage repository or databases 126. In one example embodiment, the databases 126 includes storage devices that store documents to be processed by the invocation system 122 and the process application 130. For example, the databases 126 include a library of process applications (e.g., operation request A corresponds to process A performed by process application A that locally resides on application servers 104 or externally resides on the third-party server 112. The databases 126 can also include a directory of users of a group (e.g., the directory indicates a relationship between users of the group such as: user A requires user B input for operation request A).

Additionally, a third-party application 114 executing on a third-party server 112, is shown as having programmatic access to the application server 116 via the programmatic interface provided by the Application Program Interface (API) server 118. For example, the third-party application 114, using information retrieved from the application server 116, may support one or more features or functions on a website hosted by the third party. For example, the third-party application 114 provides a process algorithm corresponding to the operation request detected by invocation system 122 to the process application 130. In another example, the third-party application 114 includes the process application 130 corresponding to the operation request. In another example, the third-party application 114 operates a lookup directory that identifies a process application corresponding to the operation request, identifies one or more group member that is pertinent to the operation request, accesses a directory of users from an enterprise associated with the group members to determine a relationship between the group members.

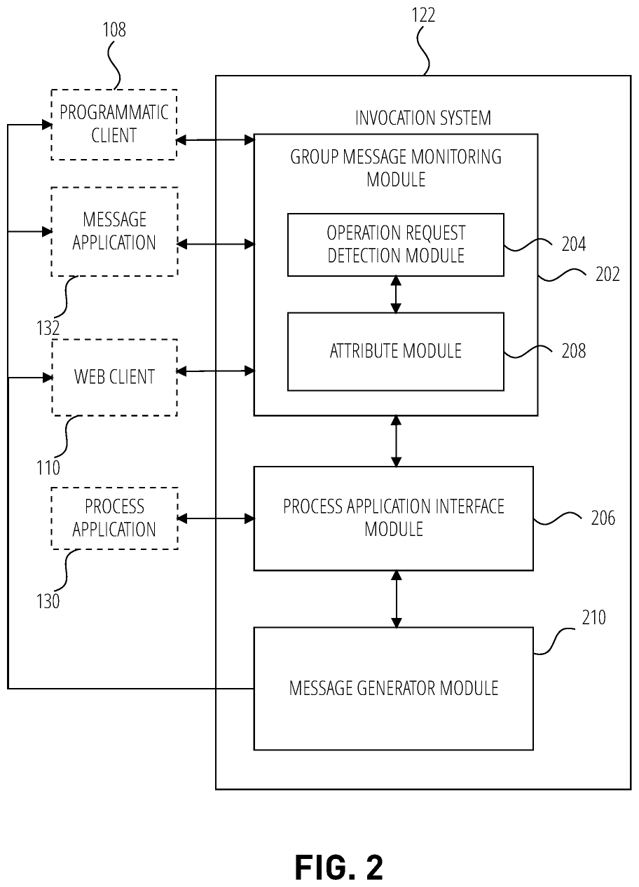

FIG. 2 is a block diagram illustrating an invocation system 122 in accordance with one example embodiment. The invocation system 122 includes a group message monitoring module 202, a process application interface module 206, and a message generator module 210. The invocation system 122 communicates with the programmatic client 108, the message application 132, the web client 110, and the process application 130.

The group message monitoring module 202 monitors group messages communicated by group members. For example, the group message monitoring module 202 accesses (through an application programming interface (API)) the message application 132 to monitor messages associated with a group. In another example, the group message monitoring module 202 interfaces (through an API) with the programmatic client 108 and the web client 110 to retrieve group messages.

The group message monitoring module 202 includes an operation request detection module 204 and an attribute module 208. The operation request detection module 204 parses each new group message in a message group to identify an operation request. In one example, the operation request detection module 204 looks up an operation library to determine whether a content of the group message includes a command or an operation request of an application (external to the message application 132). For example, the operation request detection module 204 detects that the content of a group message includes “@Approval.” The operation request detection module 204 determines that the “@Approval” corresponds to an approval operation request for a process application (e.g., approval process application X).

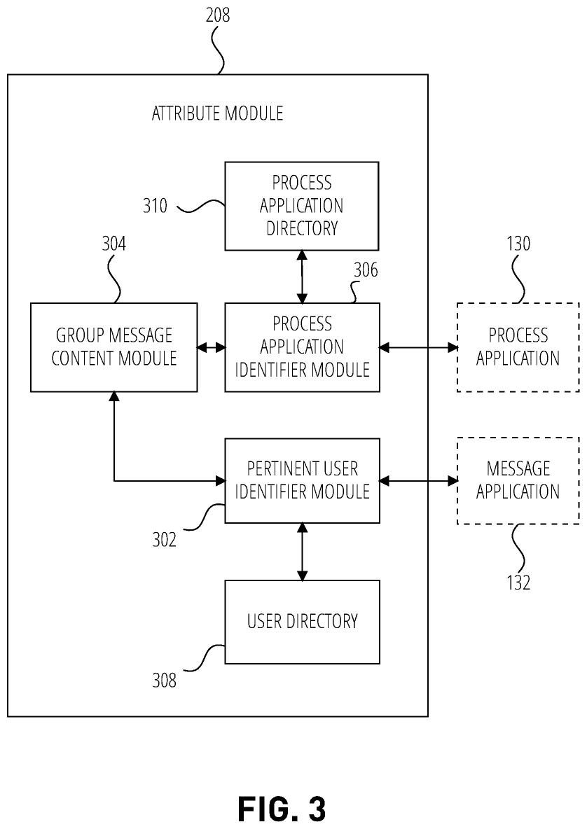

The attribute module 208 identifies a user identification (e.g., user ID) of the group member (e.g., first group member) who submitted the operation request and identifies a second group member based on the relationship between the first group member and the second group member. In another example, the attribute module 208 identifies the second group member based on the operation request detected by the operation request detection module 204. In yet another example, the attribute module 208 collects other types of data: tenant ID (e.g., enterprise identifier of the user), context (e.g., name of messaging application, name of the group chat, a local language of user), other parameters (e.g., name of users that the process depends on their input, final user input, intermediary user input, descriptions of the types of input), and message from the user 128. An example embodiment of the attribute module 208 is illustrated in FIG. 3 and described further below.

The process application interface module 206 communicates with the process application 130 via an API. For example, the process application interface module 206 provides the operation request along with parameters/attributes to the process application 130. The process application interface module 206 receives an output of the process corresponding to the operation request from the process application 130.

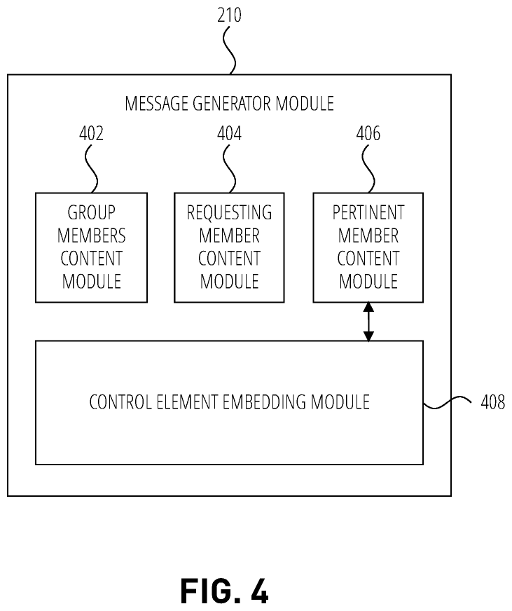

The message generator module 210 generates a second group message and sends the second group message to the group members using the message application 132. The message generator module 210 generates the second group message based on the output of the operation request performed at the process application 130. For example, the second message indicates that the first group member has requested for an approval for a task from a second group member. The message generator module 210 sends the second message to all group members using the message application 132. In one example embodiment, the message generator module 210 embeds a control element in the second message based on output of the process (corresponding to the approval request operation) that is performed at process application 130. For example, the control element includes several input elements indicating different user selections (e.g., “approved”, “check with user X for this request”, “denied”, “need more info such as X”, “hold until condition Y”). The message generator module 210 embeds the control element only for the second message designated for the second group member. In other words, the other group members cannot view and do not have access to the embedded control element. An example embodiment of the message generator module 210 is illustrated in FIG. 4 and described further below.

FIG. 3 illustrates a block diagram illustrating an attribute module in accordance with one example embodiment. The attribute module 208 includes a pertinent user identifier module 302, a group message content module 304, a process application identifier module 306, a user directory 308, and a process application directory 310.

The group message content module 304 accesses a content of the group message from the first group member. For example, the content of the group message indicates an operation request.

The process application identifier module 306 accesses the process application directory 310 to identify a process application corresponding to the operation request. The process application directory 310 includes a mapping between an operation request and a process application. After the process application directory 310 identifies the process application corresponding to the operation request, the process application directory 310 invokes the process corresponding to the operation request at the corresponding process application (e.g., process application 130).

The pertinent user identifier module 302 accesses the user directory 308 to identify a second group member (that is pertinent or relevant or required by the operation request from the first group member). After the pertinent user identifier module 302 identifies the second group member based on a combination an identification of the operation request, an identification of the process application 130, and an identification of the first group member, the pertinent user identifier module 302 provides the identification of the second group member to the message application 132.

FIG. 4 illustrates a block diagram illustrating a message generator module in accordance with one example embodiment. The message generator module 210 includes a group members content module 402, a requesting member content module 404, a pertinent member content module 406, and a control element embedding module 408.

The group members content module 402 generates a first version of the second group message. The content of the first version of the second group message can be viewed and is accessible by all group members. In one example, the content of the first version of the second group message includes first output of the process application 130. For example, the content of the first version of the second group message includes a template format that indicates that the first group member initiated a process that requires an input from the second group member.

The requesting member content module 404 generates a second version of the second group message that includes content only accessible to the first group member (who invoked the process by indicating the operation request in the content of the first group message). The second version of the second group message may include additional data can only be accessible by the first group member. Examples of additional data include time of operation request, identification of the process application, identification of one or more group members required to provide input as part of the process, estimated completion time of the process, comments from the second group member, and so forth).

The pertinent member content module 406 generates a third version of the second group message that includes content only accessible to the second group member. In one example, the control element embedding module 408 embeds a control element in the third version of the second group message. Only the second group member can view and access the control element. For example, the second group message includes a menu of options for the second group member to select as user input.

In another example embodiment, the pertinent member content module 406 determines that the second group message is designated for the second group member and in response, the pertinent member content module 406 only embeds the control element in the second group message designed for the second group member.

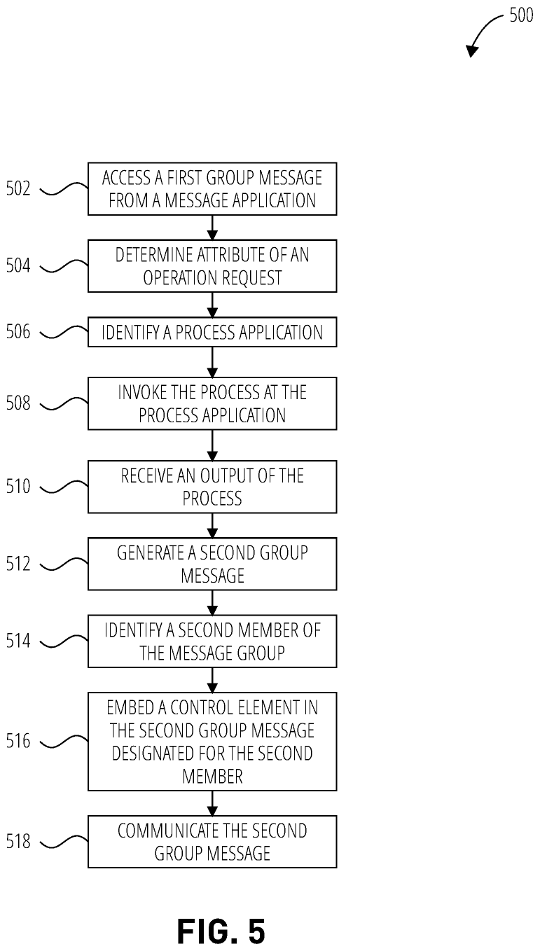

FIG. 5 is a flow diagram illustrating a method for invoking a process in accordance with one example embodiment. Operations in the method 500 may be performed by the invocation system 122, using components (e.g., modules, engines) described above with respect to FIG. 2. Accordingly, the method 500 is described by way of example with reference to the invocation system 122. However, it shall be appreciated that at least some of the operations of the method 500 may be deployed on various other hardware configurations or be performed by similar components residing elsewhere. For example, some of the operations may be performed at the client device 106 or at the third-party server 112.

At block 502, the group message monitoring module 202 accesses a first group message being communicated from a first group member to other group members of a communication application (e.g., message application 132). In another example, the group message monitoring module 202 parses a content of the first group message to detect an operation request.

At block 504, the attribute module 208 determines an attribute of the operation request based on the content of the first group message. For example, the attribute module 208 determines the attribute to include a type of operation, a process application corresponding to the type of operation, a user identifier of a first group member invoking the operation request, a user identifier of a second group member associated with the type of operation and the user identifier of the first group member.

At block 506, the attribute module 208 identifies a process application associated with the operation request and the attribute of the operation request. For example, the attribute module 208 accesses a look-up table that maps users, process type, and process application.

At block 508, the process application interface module 206 invokes the process (e.g., calls for the operation of the process) at the process application 130. For example, the process application interface module 206 calls for the process by submitting the operation request along with the parameters to the process application 130. In another example, the process application interface module 206 identifies the process application corresponding to the operation request and submits the operation request to the corresponding process application.

At block 510, the process application interface module 206 receives an output of the process from the process application 130. For example, the output indicates that a type of workflow process, the name of the group member who invoked the process, and the name of the group member pertinent to the process.

At block 512, the message generator module 210 generates a second group message based on the output of the process received from the process application 130. For example, the output of the process may be formatted using a template format (e.g., a card) and included in the second group message. The second group message is broadcast to all group members.

At block 514, the attribute module 208 identifies a second member of the message group based on the output of the process application 130, based on an attribute of the operation request (e.g., identification of the second member provided by the first group member in the first group message, identification of the process application 130 in a content of the first message group).

At block 516, the message generator module 210 embeds a control element in the second group message designated for the second group member. For example, only the second group member can view and has access to the embedded control element in the second group message. The other group members do not have access to the embedded control element. In other words, the message generator module 210 excludes the control element from the second group message when designated for the other group members.

At block 518, the message generator module 210 communicates the second group message to the second member using the message application 132. In another example, the message generator module 210 can communicate the second group message to the programmatic client 108 or the web client 110 of the second member. The message generator module 210 also communicates the second group message to all group members. In another example, the message generator module 210 communicates different versions of the second group message based on a recipient of the group (e.g., the first member, the second member, all other members of the group).

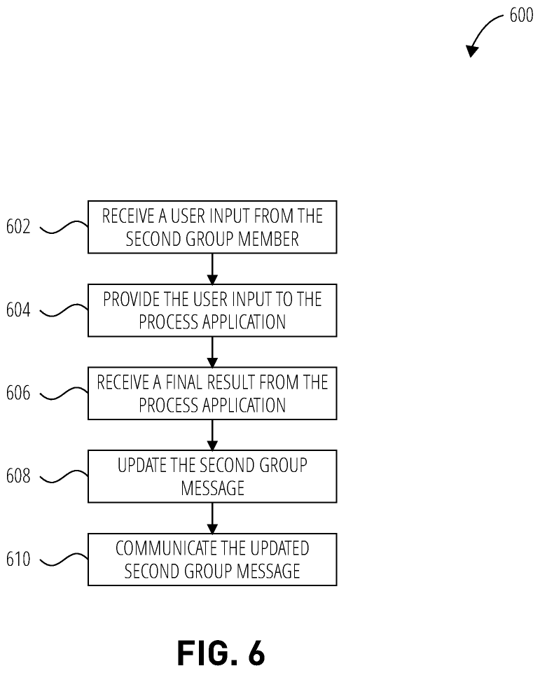

FIG. 6 is a flow diagram illustrating a method for updating a message in accordance with one example embodiment. Operations in the method 600 may be performed by the invocation system 122, using components (e.g., modules, engines) described above with respect to FIG. 2. Accordingly, the method 600 is described by way of example with reference to the invocation system 122. However, it shall be appreciated that at least some of the operations of the method 600 may be deployed on various other hardware configurations or be performed by similar components residing elsewhere. For example, some of the operations may be performed at the client device 106.

At block 602, the group message monitoring module 202 receives a user input from the second member. For example, the group message monitoring module 202 detects a selection of a user input element from the embedded control element in the second group message. For example, the second member selects “approved” from the embedded control element.

At block 604, the process application interface module 206 provides the user input from the second member to the process application 130 to continue processing the process workflow. For example, when the second member selects the particular user input, the process application interface module 206 generates a hash or a token corresponding to the particular user input. The process application interface module 206 submits the hash or token to the process application 130. The process application 130 continues operating the process based on the received hash or token.

At block 606, the process application interface module 206 receives a final result from the process application 130. The process application interface module 206 provides the final result to the message generator module 210.

At block 608, the message generator module 210 updates the second group message based on the final result. For example, the second group message indicates the final outcome of the operation request (e.g., a request for a task has been approved by the second member).

At block 610, the message generator module 210 updates the second group message to indicate the operation request and the final outcome of the operation request. In another example, the message generator module 210 generates a third group message that indicates only the final outcome of the operation request.

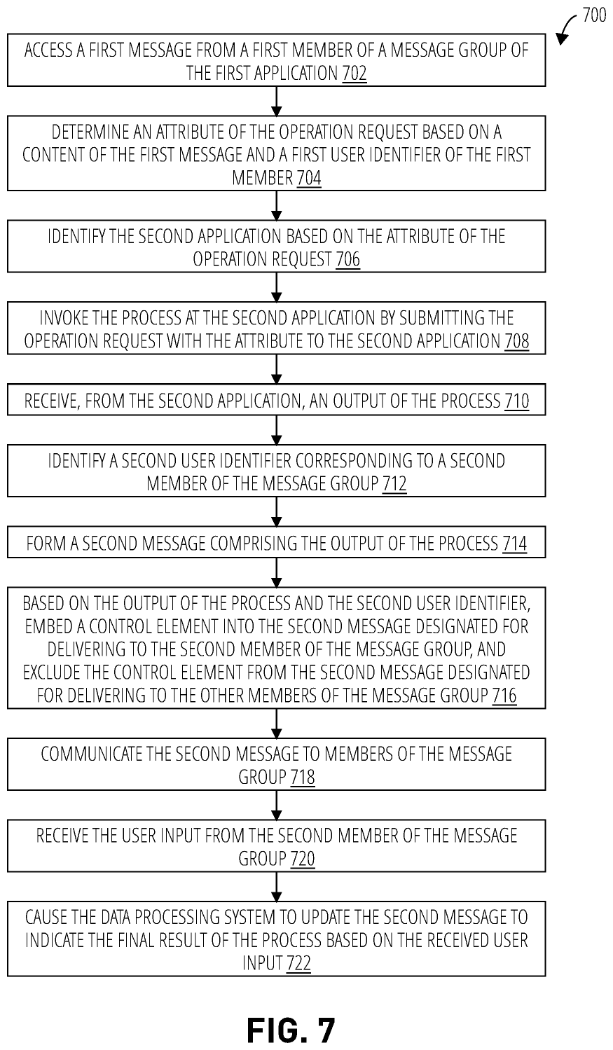

FIG. 7 is a flow diagram illustrating a routine 700 in accordance with one example embodiment. In block 702, routine 700 accesses a first message from a first member of a message group of the first application, the first message indicating an operation request. In block 704, routine 700 determines an attribute of the operation request based on a content of the first message and a first user identifier of the first member. In block 706, routine 700 identifies the second application based on the attribute of the operation request. In block 708, routine 700 invokes the process at the second application by submitting the operation request with the attribute to the second application, the second application performing the process corresponding to the operation request with the attribute. In block 710, routine 700 receives, from the second application, an output of the process. In block 712, routine 700 identifies a second user identifier corresponding to a second member of the message group. In block 714, routine 700 forms a second message comprising the output of the process. In block 716, routine 700 based on the output of the process and the second user identifier, embeds a control element into the second message designated for delivering to the second member of the message group, and excluding the control element from the second message designated for delivering to the other members of the message group, wherein the embedded control element, upon activation based on a user input from the second member of the message group, causes the data processing system to interface with the second application to access a final result of the process from the second application. In block 718, routine 700 communicates the second message, using the first application, to members of the message group. In block 720, routine 700 receives the user input from a device of the second member of the message group. In block 722, routine 700 causes the data processing system to update the second message to indicate the final result of the process based on the received user input.

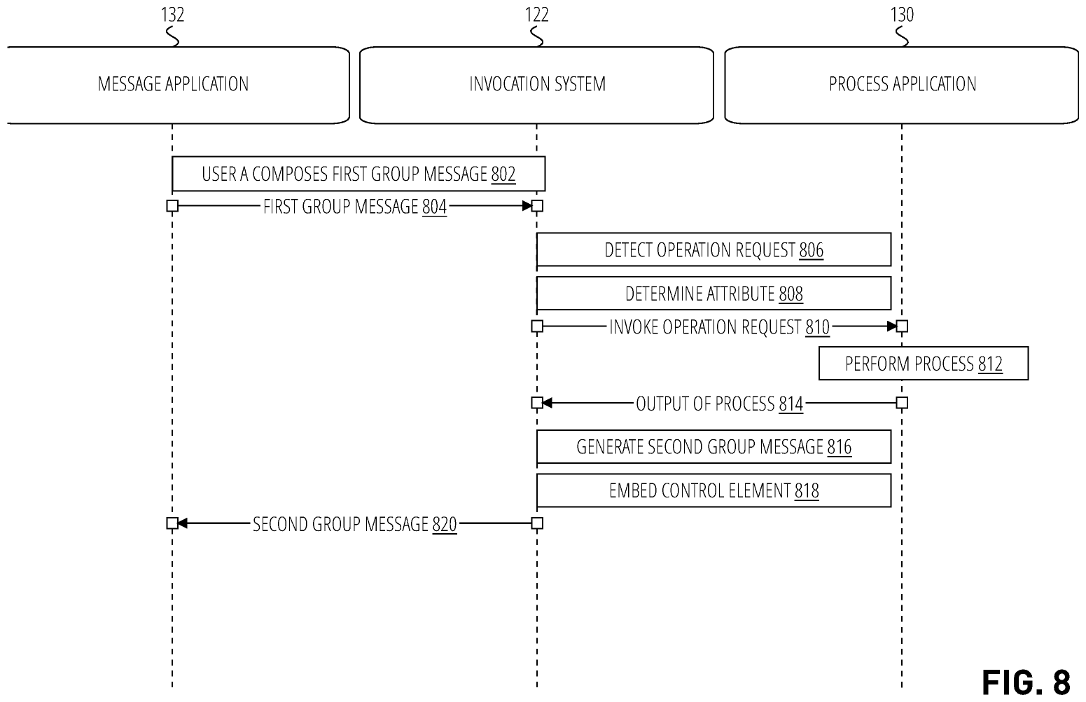

FIG. 8 illustrates an interaction diagram illustrating an operation of the invocation system 122 in accordance with one example embodiment. At 802, a user A uses the message application 132 to compose a first group message by indicating an operation request in a content of the first group message (designated for all members of a group). At 804, the message application 132 communicates the first group message to the invocation system 122. At 806, the invocation system 122 detects an operation request in a content of the first group message. At 808, the invocation system 122 determines an attribute of the operation request. At 810, the invocation system 122 invokes the operation request at the process application 130. At 812, the process application 130 performs the process corresponding to the operation request. At 814, the process application 130 provides an intermediary output (e.g., non-final output) of the process to the invocation system 122. At 816, the invocation system 122 generates a second group message that includes the intermediary output. At 818, the invocation system 122 embeds a control element in the second group message designated for a user B (that is identified either by user A or from the content of the first group message). At 820, the invocation system 122 provides the second group message to the message application 132 to be sent out to all group members.

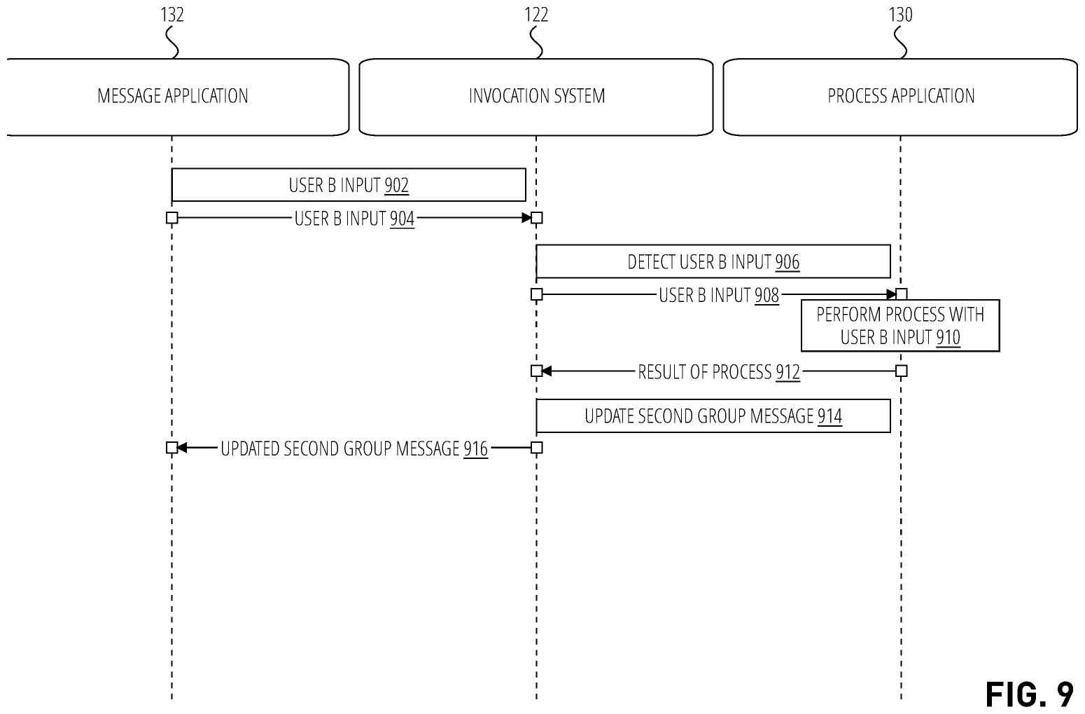

FIG. 9 illustrates an interaction diagram illustrating an operation of the invocation system 122 in accordance with one example embodiment. At 902, the message application 132 detects an input from user B from the embedded control element. At 904, the message application 132 provides the user B input to the invocation system 122. At 906, the invocation system 122 detects the user B input and provides the input selection to the process application 130 at 908. At 910, the process application 130 performs the process with user B input and generates a final result of the process based on user B input. At 912, the process application 130 sends the result of the process to the invocation system 122. The invocation system 122 updates the second group message to indicate the result of the process. At 916, the invocation system 122 sends the updated second group message to the message application 132.

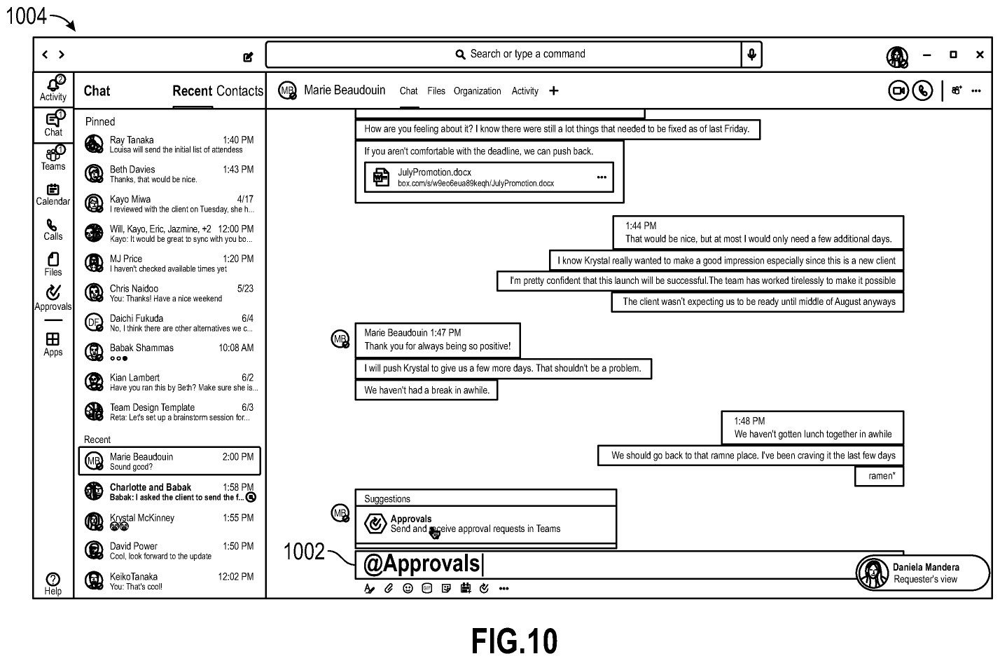

FIG. 10 illustrates a screenshot 1004 of a communication application of a first member in accordance with one example embodiment. The screenshot 1004 illustrates the operation request 1002 in a first message from the first member. In other example embodiments, the request may be submitted via the search field at the top of the screenshot 1004 or via other in-application commands represented with corresponding icons at the bottom of the screenshot 1004. The following is a list of non-limiting examples of how the workflow process request can be triggered using: a message action, message extension in a compose box, a slash command in a compose box or power bar, a file context menu, a channel context menu, and a meeting context menu.

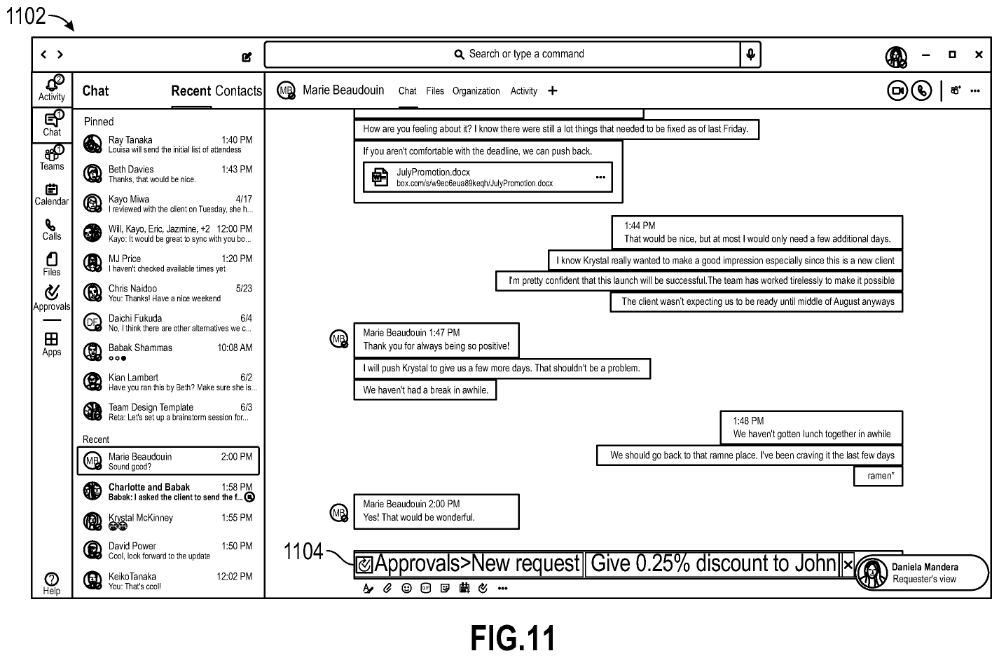

FIG. 11 illustrates a screenshot 1102 of a communication application of a first member in accordance with one example embodiment. The screenshot 1102 illustrates the operation request with attribute 1104 in a first message from the first member.

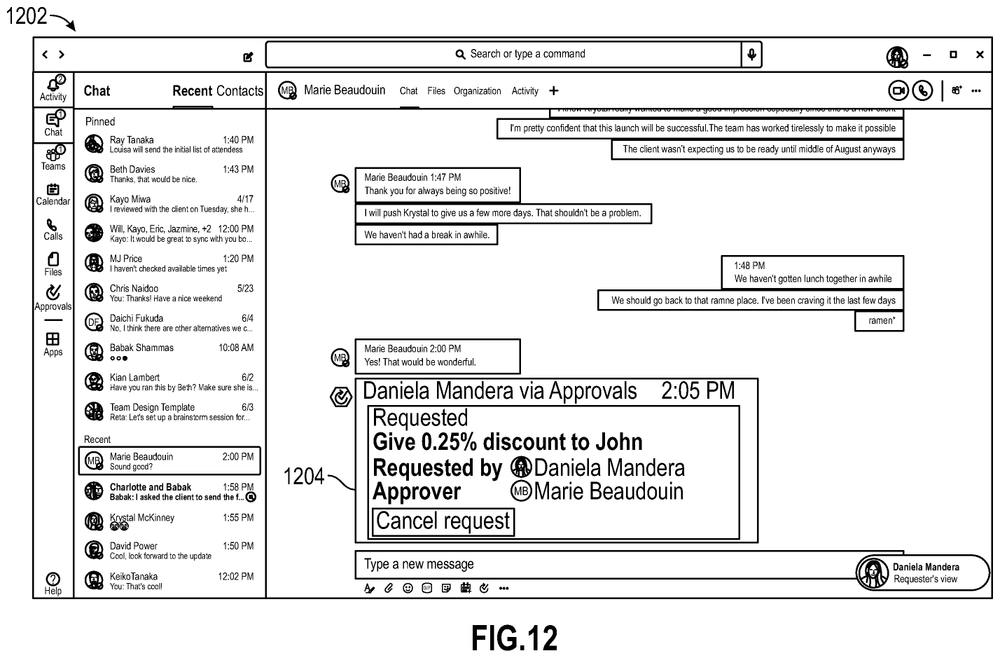

FIG. 12 illustrates screenshot 1202 of a communication application of a first member in accordance with one example embodiment. The screenshot 1202 illustrates the second message 1204.

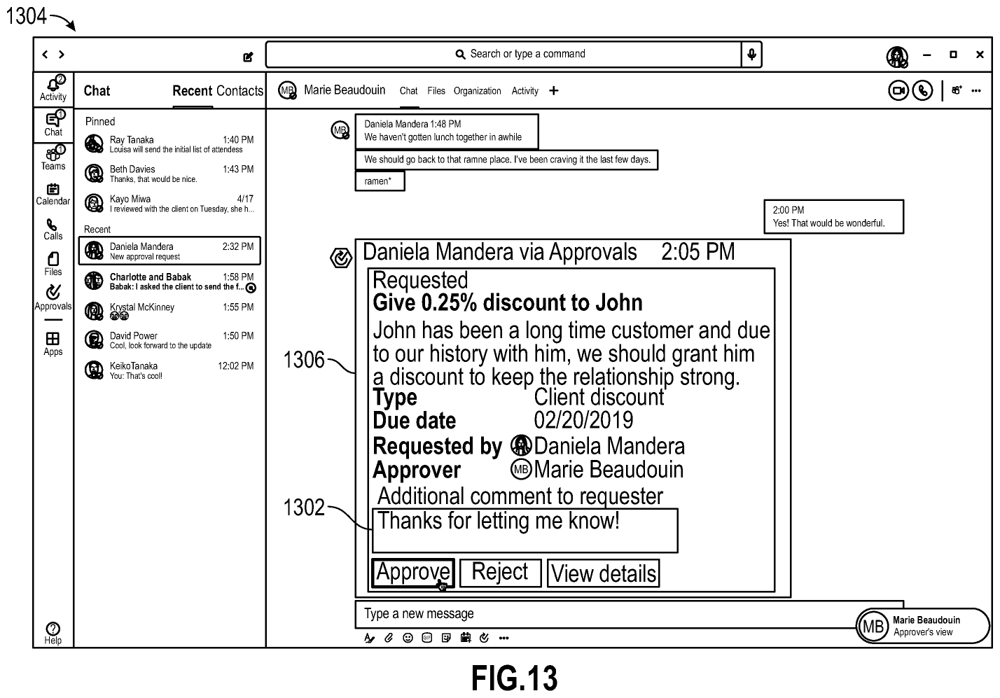

FIG. 13 illustrates a screenshot 1304 of a communication application of a second member in accordance with one example embodiment. The screenshot 1304 illustrates the second message 1306 with the embedded control element 1302.

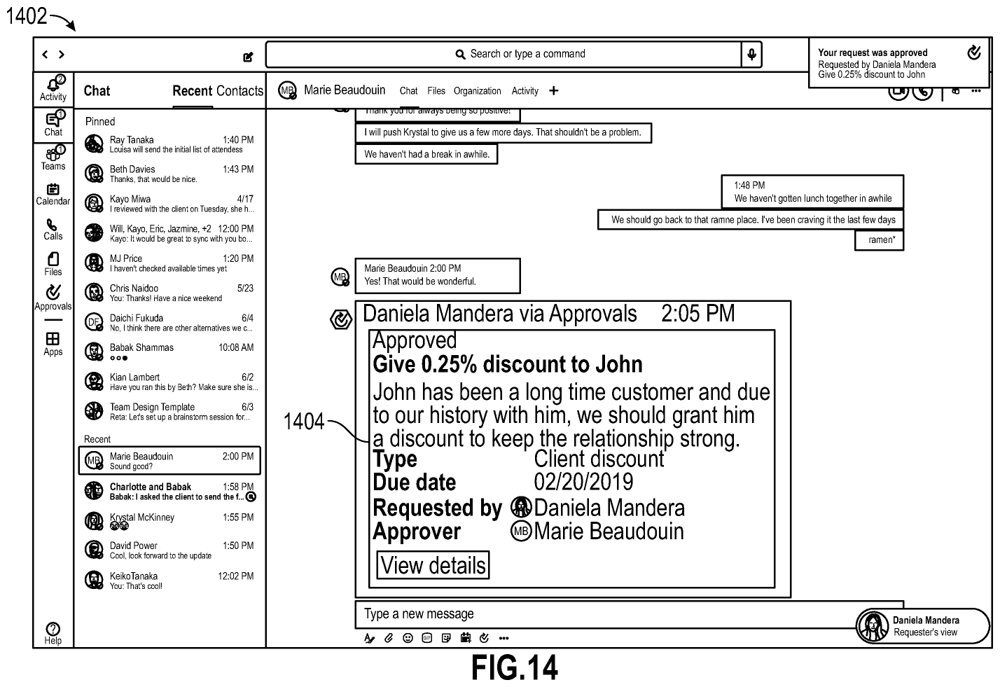

FIG. 14 illustrates a screenshot 1402 of a communication application of a first member in accordance with one example embodiment. The 1404 illustrates the second message 1404 showing the final result of the process.

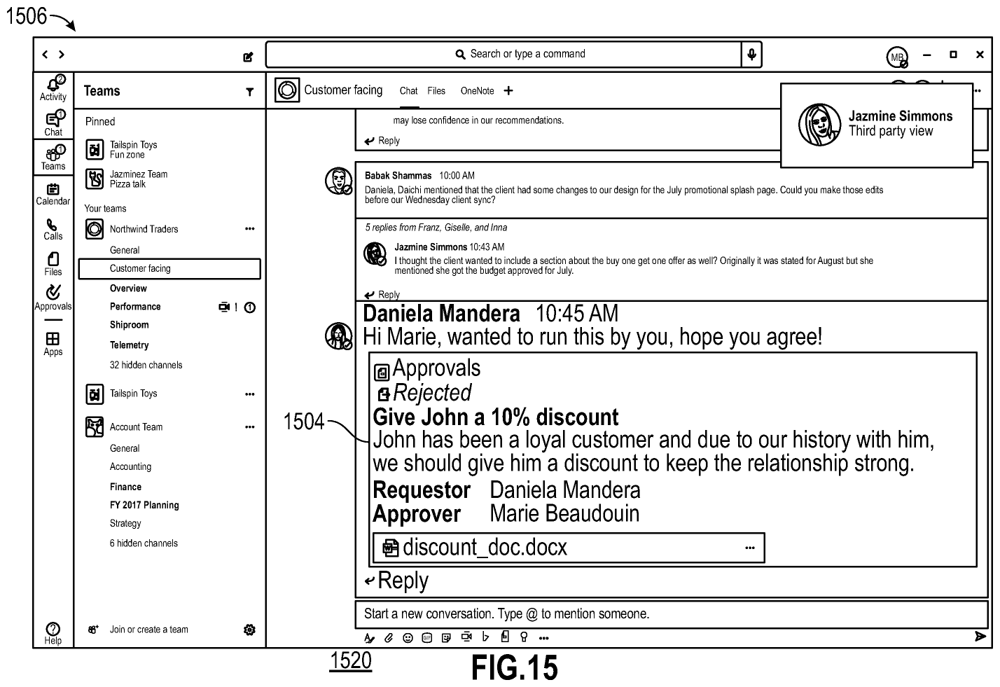

FIG. 15 illustrates a screenshot 1506 of a communication application of another group member (other than the first and second member) in accordance with one example embodiment. The screenshot 1506 illustrates a second message 1504 indicating the final result of the process.

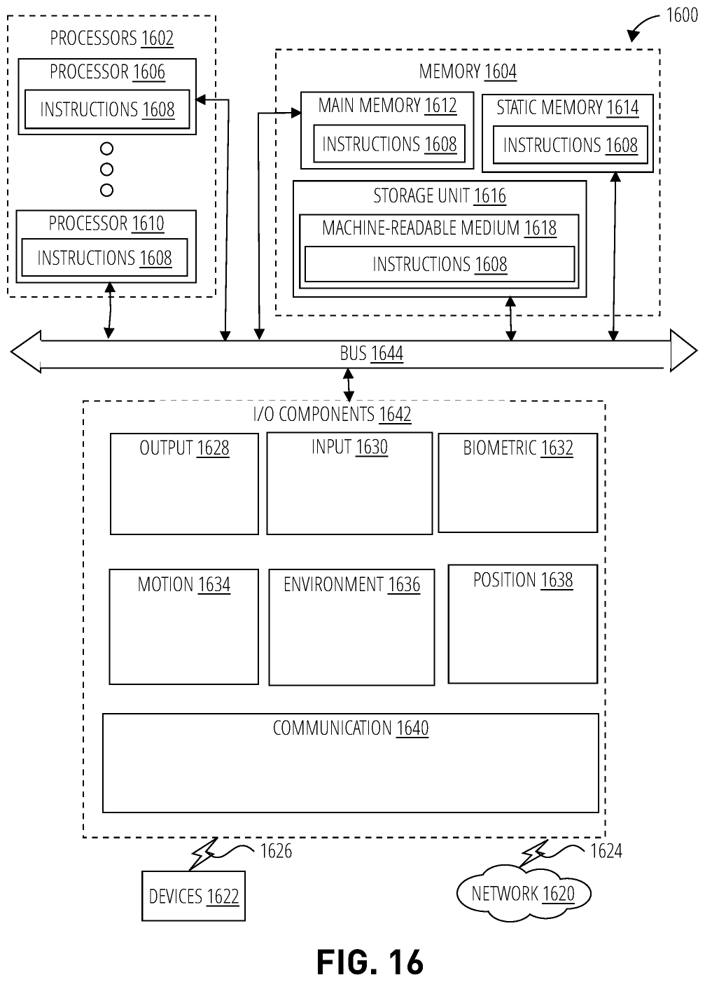

FIG. 16 is a diagrammatic representation of the machine 1600 within which instructions 1608 (e.g., software, a program, an application, an applet, an app, or other executable code) for causing the machine 1600 to perform any one or more of the methodologies discussed herein may be executed. For example, the instructions 1608 may cause the machine 1600 to execute any one or more of the methods described herein. The instructions 1608 transform the general, non-programmed machine 1600 into a particular machine 1600 programmed to carry out the described and illustrated functions in the manner described. The machine 1600 may operate as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1608, sequentially or otherwise, that specify actions to be taken by the machine 1600. Further, while only a single machine 1600 is illustrated, the term “machine” shall also be taken to include a collection of machines that individually or jointly execute the instructions 1608 to perform any one or more of the methodologies discussed herein.

The machine 1600 may include processors 1602, memory 1604, and I/O components 1642, which may be configured to communicate with each other via a bus 1644. In an example embodiment, the processors 1602 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an ASIC, a Radio-Frequency Integrated Circuit (RFIC), another Processor, or any suitable combination thereof) may include, for example, a Processor 1606 and a Processor 1610 that execute the instructions 1608. The term “Processor” is intended to include multi-core processors that may comprise two or more independent processors (sometimes referred to as “cores”) that may execute instructions contemporaneously. Although FIG. 16 shows multiple processors 1602, the machine 1600 may include a single Processor with a single core, a single Processor with multiple cores (e.g., a multi-core Processor), multiple processors with a single core, multiple processors with multiples cores, or any combination thereof.

The memory 1604 includes a main memory 1612, a static memory 1614, and a storage unit 1616, both accessible to the processors 1602 via the bus 1644. The main memory 1604, the static memory 1614, and storage unit 1616 store the instructions 1608 embodying any one or more of the methodologies or functions described herein. The instructions 1608 may also reside, completely or partially, within the main memory 1612, within the static memory 1614, within machine-readable medium 1618 within the storage unit 1616, within at least one of the processors 1602 (e.g., within the Processor's cache memory), or any suitable combination thereof, during execution thereof by the machine 1600.

The I/O components 1642 may include a wide variety of components to receive input, provide output, produce output, transmit information, exchange information, capture measurements, and so on. The specific I/O components 1642 that are included in a particular machine will depend on the type of machine. For example, portable machines such as mobile phones may include a touch input device or other such input mechanisms, while a headless server machine will likely not include such a touch input device. It will be appreciated that the I/O components 1642 may include many other components that are not shown in FIG. 16. In various example embodiments, the I/O components 1642 may include output components 1628 and input components 1630. The output components 1628 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1630 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1642 may include biometric components 1632, motion components 1634, environmental components 1636, or position components 1638, among a wide array of other components. For example, the biometric components 1632 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1634 include acceleration sensor components (e.g., accelerometer), gravitation sensor components, rotation sensor components (e.g., gyroscope), and so forth. The environmental components 1636 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1638 include location sensor components (e.g., a GPS receiver Component), altitude sensor components (e.g., altimeters or barometers that detect air pressure from which altitude may be derived), orientation sensor components (e.g., magnetometers), and the like.

Communication may be implemented using a wide variety of technologies. The I/O components 1642 further include communication components 1640 operable to couple the machine 1600 to a network 1620 or devices 1622 via a coupling 1624 and a coupling 1626, respectively. For example, the communication components 1640 may include a network interface Component or another suitable device to interface with the network 1620. In further examples, the communication components 1640 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 1622 may be another machine or any of a wide variety of peripheral devices (e.g., a peripheral device coupled via a USB).

Moreover, the communication components 1640 may detect identifiers or include components operable to detect identifiers. For example, the communication components 1640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1640, such as location via Internet Protocol (IP) geolocation, location via Wi-Fi® signal triangulation, location via detecting an NFC beacon signal that may indicate a particular location, and so forth.

The various memories (e.g., memory 1604, main memory 1612, static memory 1614, and/or memory of the processors 1602) and/or storage unit 1616 may store one or more sets of instructions and data structures (e.g., software) embodying or used by any one or more of the methodologies or functions described herein. These instructions (e.g., the instructions 1608), when executed by processors 1602, cause various operations to implement the disclosed embodiments.

The instructions 1608 may be transmitted or received over the network 1620, using a transmission medium, via a network interface device (e.g., a network interface Component included in the communication components 1640) and using any one of a number of well-known transfer protocols (e.g., hypertext transfer protocol (HTTP)). Similarly, the instructions 1608 may be transmitted or received using a transmission medium via the coupling 1626 (e.g., a peer-to-peer coupling) to the devices 1622.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

### EXAMPLES

Example 1 is a computer-implemented method performed by a data processing system for invoking, from a first application, a process of a second application, the method comprising: accessing a first message from a first member of a message group of the first application, the first message indicating an operation request; determining an attribute of the operation request based on a content of the first message and a first user identifier of the first member; identifying the second application based on the attribute of the operation request; invoking the process at the second application by submitting the operation request with the attribute to the second application, the second application performing the process corresponding to the operation request with the attribute; receiving, from the second application, an output of the process; identifying a second user identifier corresponding to a second member of the message group; forming a second message comprising the output of the process; based on the output of the process and the second user identifier, embedding a control element into the second message designated for delivering to the second member of the message group, and excluding the control element from the second message designated for delivering to the other members of the message group, wherein the embedded control element, upon activation based on a user input from the second member of the message group, causes the data processing system to interface with the second application to convey the user input from the second member and to access a final result based on the user input from the second application; communicating the second message, using the first application, to members of the message group; receiving the user input from a device of the second member of the message group; interfacing with the second application to convey the received user input from the second member to the second application; responsive to conveying the received user input from the second member to the second application, receiving the final result of the process based on the user input from the second application; and causing the data processing system to send an update message indicating the final result of the process based on the received user input.

Example 2 includes example 1, wherein the first application identifies the second user identifier based on the content of the first message and the first user identifier.

Example 3 includes example 1, wherein the second application identifies the second user identifier based on the output of the process.

Example 4 includes example 1, wherein the output of the process in the second message designated for delivering to all members of the message group is displayed to all members of the message group, wherein the control element embedded in the second message designated for delivering to the second member of the message group is only accessible by the second member of the message group.

Example 5 includes example 1, wherein the first message identifies the second application.

Example 6 includes example 1, wherein the method further comprising: accessing an application library that maps one of a plurality of operation requests to one of a plurality of applications; identifying, using the application library, the second application corresponding to the operation request; and identifying, using the application library, the attribute corresponding to the operation request; identifying a value of the attribute based on the first user identifier; and providing the attribute and the value of the attribute to the second application, the process being performed at the second application based on the attribute and the value of the attribute.

Example 7 includes example 6, wherein identifying the value of the attribute comprises: accessing a directory, the directory identifying a relationship between the first member and one or more members of the message group; and identifying the second member based on the identified relationship.

Example 8 includes example 1, wherein the second message comprises first content element, second content element, and third content element, wherein the first content element is viewable only by the first member of the message group, wherein the second content element includes the embedded control element and is viewable only by the second member of the message group, wherein the third content element is viewable by all members of the message group.

Example 9 includes example 8, wherein the first content element of the second message comprises a note from the second member of the message group, wherein the second content element identifies a plurality of selection inputs of the process, wherein the third content element identifies a selection input of the plurality of selection inputs based on the user input from the second member of the message group.

Example 10 includes example 1, wherein the first application comprises a communication application, wherein the second message comprises a template element that identifies the operation request, the first member, and the second member.

Example 11 includes example 1, wherein the first message comprises a chat message associated with the message group in an online chat group.

Example 12 includes example 1, wherein the first message comprises an email thread that identifies members of an email group.

Example 13 includes example 1, wherein the attribute indicates at least one of the first user identifier, an organization identifier, an operation context of the first application associated with the first user identifier, or the content of the first message.

Example 14 is a computer-readable storage medium, the computer-readable storage medium including instructions that when executed by a computer, cause the computer to perform operations implementing the method of any of example 1 to example 13.

Example 15 is a computing apparatus, the computing apparatus comprising: a Processor; and a memory storing instructions that, when executed by the Processor, configure the apparatus to perform operations comprising: accessing a first message from a first member of a message group of the first application, the first message indicating an operation request; determining an attribute of the operation request based on a content of the first message and a first user identifier of the first member; identifying the second application based on the attribute of the operation request; invoking the process at the second application by submitting the operation request with the attribute to the second application, the second application performing the process corresponding to the operation request with the attribute; receiving, from the second application, an output of the process; identifying a second user identifier corresponding to a second member of the message group; forming a second message comprising the output of the process; based on the output of the process and the second user identifier, embedding a control element into the second message designated for delivering to the second member of the message group, and excluding the control element from the second message designated for delivering to the other members of the message group, wherein the embedded control element, upon activation based on a user input from the second member of the message group, causes the data processing system to interface with the second application to convey the user input from the second member and to access a final result based on the user input from the second application; communicating the second message, using the first application, to members of the message group; receiving the user input from a device of the second member of the message group; interfacing with the second application to convey the received user input from the second member to the second application; responsive to conveying the received user input from the second member to the second application, receiving the final result of the process based on the user input from the second application; and causing the data processing system to send an update message indicating the final result of the process based on the received user input.

1. A computer-implemented method performed by a data processing system for invoking, from a first application, a process of a second application, the method comprising:
accessing a first message from a first member of a message group of the first application, the first message indicating an operation request;
determining an attribute of the operation request based on a content of the first message and a first user identifier of the first member;
identifying the second application based on the attribute of the operation request;
invoking the process at the second application by submitting the operation request with the attribute to the second application; the second application performing the process corresponding to the operation request with the attribute;
receiving, from the second application, an output of the process;
identifying a second user identifier corresponding to a second member of the message group;
forming a second message comprising the output of the process;
based on the output of the process and the second user identifier, embedding a control element into the second message designated for delivering to the second member of the message group, and excluding the control element from the second message designated for delivering to the other members of the message group, wherein the embedded control element, upon activation based on a user input from the second member of the message group, causes the data processing system to interface with the second application to convey the user input from the second member and to access a final result based on the user input from the second application;
communicating the second message, using the first application, to members of the message group;
receiving the user input from a device of the second member of the message group;
interfacing with the second application to convey the received user input from the second member to the second application;
responsive to conveying the received user input from the second member to the second application, receiving the final result of the process based on the user input from the second application; and
causing the data processing system to send an update message indicating the final result of the process based on the received user input.

2. The computer-implemented method of claim 1, wherein the first application identifies the second user identifier based on the content of the first message and the first user identifier.

3. The computer-implemented method of claim 1, wherein the second application identifies the second user identifier based on the output of the process.

4. The computer-implemented method of claim 1, wherein the output of the process in the second message designated for delivering to all members of the message group is displayed to all members of the message group; wherein the control element embedded in the second message designated for delivering to the second member of the message group is only accessible by the second member of the message group.

5. The computer-implemented method of claim 1, wherein the first message identifies the second application.

6. The computer-implemented method of claim 1, comprising:
accessing an application library that maps one of a plurality of operation requests to one of a plurality of applications;
identifying, using the application library, the second application corresponding to the operation request;
identifying, using the application library, the attribute corresponding to the operation request;
identifying a value of the attribute based on the first user identifier; and
providing the attribute and the value of the attribute to the second application, the process being performed at the second application based on the attribute and the value of the attribute.

7. The computer-implemented method of claim 6, wherein identifying the value of the attribute comprises:
accessing a directory, the directory identifying a relationship between the first member and one or more members of the message group; and
identifying the second member based on the identified relationship.

8. The computer-implemented method of claim 1, wherein the second message comprises first content element, second content element, and third content element,
wherein the first content element is viewable only by the first member of the message group,
wherein the second content element includes the embedded control element and is viewable only by the second member of the message group,
wherein the third content element is viewable by all members of the message group.

9. The computer-implemented method of claim 8, wherein the first content element of the second message comprises a note from the second member of the message group, wherein the second content element identifies a plurality of selection inputs of the process, wherein the third content element identifies a selection input of the plurality of selection inputs based on the user input from the second member of the message group.

10. The computer-implemented method of claim 1, wherein the first application comprises a communication application, wherein the second message comprises a template element that identifies the operation request, the first member, and the second member.

11. The computer-implemented method of claim 1, wherein the first message comprises a chat message associated with the message group in an online chat group.

12. The computer-implemented method of claim 1, wherein the first message comprises an email thread that identifies members of an email group.

13. The computer-implemented method of claim 1, wherein the attribute indicates at least one of the first user identifier, an organization identifier, an operation context of the first application associated with the first user identifier, or the content of the first message.

14. A computer-readable storage medium, the computer-readable storage medium including instructions that when executed by a computer, cause the computer to perform operations implementing the method of claim 1.

15. A computing apparatus, the computing apparatus comprising:
a processor; and
a memory storing instructions that, when executed by the processor, configure the apparatus to perform operations comprising:
accessing a first message from a first member of a message group of the first application, the first message indicating an operation request;
determining an attribute of the operation request based on a content of the first message and a first user identifier of the first member;
identifying the second application based on the attribute of the operation request;
invoking a process at the second application by submitting the operation request with the attribute to the second application, the second application performing the process corresponding to the operation request with the attribute;
receiving, from the second application, an output of the process;
identifying a second user identifier corresponding to a second member of the message group;
forming a second message comprising the output of the process;
based on the output of the process and the second user identifier, embedding a control element into the second message designated for delivering to the second member of the message group, and excluding the control element from the second message designated for delivering to the other members of the message group, wherein the embedded control element, upon activation based on a user input from the second member of the message group, causes the data processing system to interface with the second application to convey the user input from the second member and to access a final result based on the user input from the second application;
communicating the second message, using the first application, to members of the message group;
receiving the user input from a device of the second member of the message group;
interfacing with the second application to convey the received user input from the second member to the second application;
responsive to conveying the received user input from the second member to the second application, receiving the final result of the process based on the user input from the second application; and
causing the data processing system to send an update message indicating the final result of the process based on the received user input.
